(19) United States
(12) Patent Application Publication
(10) Pub. No.: US 2019/0116760 A1
(43) Pub. Date: Apr. 25, 2019

(54) Nail Filer and Grooming Tool for Pets and Other Animals

(71) Applicant: Scott Leonard, Allentown, PA (US)

(72) Inventor: Scott Leonard, Allentown, PA (US)

(21) Appl. No.: 15/792,681

(22) Filed: Oct. 24, 2017

(51) Int. Cl. A01K 17/00; A01K 13/00

(52) U.S. Cl. CPC A01K 17/00; A01K 13/00

(57) ABSTRACT

The present invention is a grinding apparatus which will increase efficiency and safety of grooming and caring for dogs and cats.

### CROSS REFERENCE TO RELATED APPLICATIONS

The present application claims priority under 35 U.S.C. § 119(e) from U.S. Provisional Application Ser. No. 62/411,860, filed Oct. 24, 2016. The entire contents of this application are incorporated by reference herein.

### FIELD OF THE INVENTION

The present invention pertains most notably to the fields of animal grooming and care.

### BACKGROUND OF THE INVENTION

The present invention will be marketed primarily in the industries of household grooming tools and animal care. There is a large business for do-it-yourself products for the trimming, clipping, cleansing and otherwise maintaining of keratin-based body parts of domestic animals and pets, including nails, claws, cuticles, and beaks. Current commercially available products exist for the care and grooming of domestic animals, but have several and various flaws. Clippers can be used to trim and cut nails but are dangerous and risk injury to both the person operating the tool and the animal, due to the unpredictability of the animal's response. Similarly, there are sanding and grinding tools, which are commercially available. However, these are difficult to use as they require a near-motionless animal in order to facilitate the grooming process.

Some manufacturers of grooming products have attempted to cap or cover a grinding or filing stone, so as to catch and immobilize the nail to be filed. While this solves the problem of a fidgety animal and moving target, the risk for severe injury to the animal outweighs any benefit. The cap/enclosure is also capable of breaking or ripping the nail, as it attempts to temporarily restrain the nail for filing. A hasty or anxious move by the animal will cause the nail to bend or break, causing pain and greater anxiety about the grooming process, or worse, serious injury to the nail or paw. No product currently exists which conveniently and safely holds in place an animal's nail, claw or other appendage while gently dulling the nail's sharpness and length.

### SUMMARY OF THE INVENTION

The present invention is to be used in animal grooming and hygiene. Current technology provides many versions of grooming tools, including handheld grinders with various shortcomings—all of which feature round or similarly shaped grinders atop handheld rotary tools. If the nail does not enter the grinding bay with enough security to fit snugly, there can be danger to the animal, which also poses a danger to the person operating the device. The present invention provides a safe and easy to use grinding apparatus formed from an abrasive or otherwise coarse and durable substance in the shape of a cup or cone. It will function by rotating around its central concave axis at varying rotational velocities and in both clockwise and counterclockwise directions when connected to a power source. Once connected to and/or outfitted with one or more support, connecting, and gripping structures, such as a pedestal, a support structure for handling by a user, means of activating and deactivating the apparatus, means of controlling the rotational speed and direction of the abrasive member, and a power source, it will provide a convenient and safe way to file or trim the nails or claws of animals.

### BRIEF DESCRIPTION OF THE FIGURE

Unless otherwise stated, all dimensions are in inches and drawings are not to scale.

FIG. 1 depicts various perspectives of the present invention.

### DETAILED DESCRIPTION OF THE INVENTION

The present invention comprises an apparatus for and method of grinding, filing and otherwise grooming the claws, nails, beaks and other keratin or protein-based appendages of pets. The head of the tool will be in the shape of a concave cup, with the intention that it would keep the pet's nail within the cup structure and prevent the pet's nail from slipping off the grinding mechanism and/or causing an injury. Such a mechanism has the further benefit of creating a smooth complete finish of the nail and provides a level of comfort to both owner and pet. The concave filing mechanism is positioned at the top of a small pedestal of plastic or otherwise that may insert into a handheld rotary tool.

The present invention will function by way of a concave cup which would gently but securely hold in place the nail of a dog, cat, bird, or other pet, while it polishes the tip and outer surface layers of nail, the extent of which is determined by the user and customizable for the pet. The polishing and reducing of the nail will occur by virtue of the rotation stone cup-shaped apparatus. The rotations per minute (“RPM”) and/or the direction of the rotation will vary depending on the type and size of the animal, the length and thickness of the nail, and the nature of the filing action required.

In a preferred embodiment, the present invention will be of dimensions and weight capable of comfortable use as a handheld tool. The handle of the present invention can be made of wood, plastic, aluminum, steel or any other rigid, lightweight material, capable of mass production.

The grinding mechanism of the present invention, in the preferred embodiment, will be made of stone, in the shape of a concave cup or cone. It may be removable or replaceable as the grinding surface becomes dull. The present invention may be customized for different species or size of animal and/or the grinding mechanism may be customized for such specific uses.

There are varying methods capable of powering the present invention, including a replaceable battery in the handle or via wire and plug.

### EXAMPLES

The present invention is more fully described by way of the following non-limiting examples and objects of the invention. These examples should, in no way, be construed as limiting the scope of the invention.

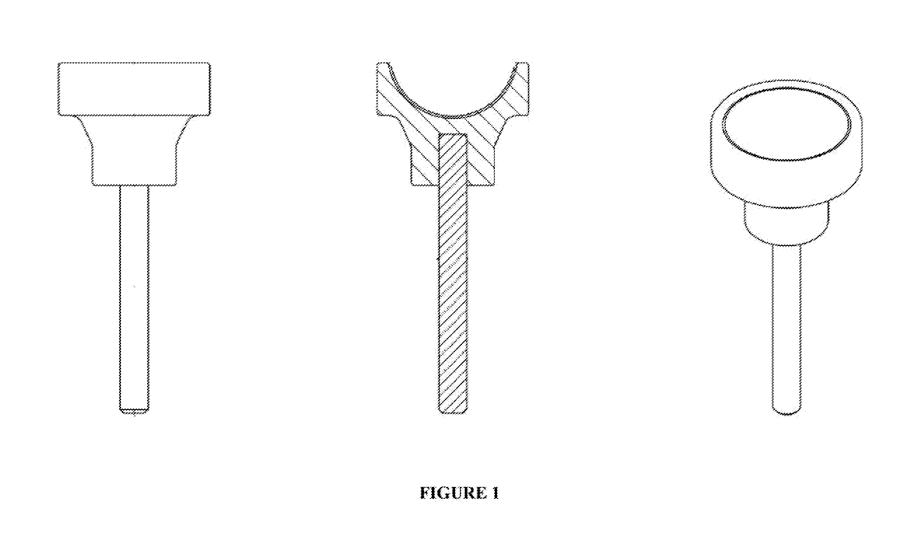

Applicant devised the present invention, while having a need for the solution it provides and discovering the unmet need therefor. The Applicant, after considering several possible iterations of the present invention, built a preliminary prototype demonstrating an embodiment and proof of principle. FIG. 1 provides perspectives and guidance for manufacturing and producing the present invention. Iterations of the Applicant's prototype and the exemplary images in FIG. 1 are examples of the various versions and embodiments of the invention and the possible modes, methods and means of its construction, which are contemplated by Applicant in this application.

In one example, the present invention can be used for larger animals, including large dogs, and feature a thick handle of approximately one to three inches in width or diameter; with a large grinding stone atop such handle, with a deep recession, capable of receiving a large nail, in both thickness and length.

In another example, the present invention can be tailored for use with animals with smaller paws, and consequently, thinner, frailer and/or shorter nails. It would consist of a smaller, concave stone cup, which would not require a large handle, as described above.

For larger animals, who are not easily frightened of noise, the RPM can be higher; whereas, the RPM can be decreased for a slower grooming process, which may be less intimidating to smaller and/or more easily excitable animals. Furthermore, the ability to alternate the rotational direction would accommodate various circumstances, including particular needs of the animal and/or injuries or sensitivities.

The foregoing examples and description of the preferred embodiments should be interpreted as illustrating, rather than as limiting, the present invention as defined herein. All variations and combinations of the features above are intended to be within the scope of this application and the variations and descriptions herein.

We claim:

1. A grinding apparatus comprising a solid, cuplike structure of abrasive and durable material, capable of rotating around its central concave point at varying rotational velocities and in both clockwise and counterclockwise directions when connected to a power source.

2. The grinding apparatus of claim 1 further comprising a pedestal for the abrasive member or other means of connection, a support structure for handling by a user, means of activating and deactivating the apparatus, means of controlling the rotational speed and direction of the abrasive member, and a power source.

3. A method of using the grinding apparatus of claim 1 or 2 for filing the nails or claws of animals.
